(19) United States
(12) Patent Application Publication
(10) Pub. No.: US 2025/0384881 A1
(43) Pub. Date: Dec. 18, 2025

(54) COMMUNICATION METHOD, ELECTRONIC DEVICE, STORAGE MEDIA, AND PRODUCTS

(71) Applicant: Beijing Zitiao Network Technology Co., Ltd., Beijing (CN)

(72) Inventors: Rong ZOU, Beijing (CN); Daoyu WANG, Beijing (CN)

(21) Appl. No.: 19/088,909

(22) Filed: Mar. 24, 2025

Related U.S. Application Data
(63) Continuation of application No. PCT/CN2024/099244, filed on Jun. 14, 2024.

(51) Int. Cl. G10L 15/22; G10L 13/033; G10L 13/08; G10L 15/00; G10L 15/02

(52) U.S. Cl. CPC G10L 15/22; G10L 13/033; G10L 13/08; G10L 15/005; G10L 15/02

(57) ABSTRACT

The disclosure relates to a communication method, an electronic device, a storage medium, and a product, which relates to the field of computer technology. The communication method includes: determining, based on an input of a first object in an interaction interface between the first object and a second object, a target scene mode from one or more scene modes configured for the second object, wherein each of the scene modes is configured with a voice feature; and controlling the second object to perform a voice interaction with the first object based on a voice feature of the target scene mode.

### CROSS-REFERENCE TO RELATED APPLICATION

The present disclosure is a continuation application, under 35 U.S.C. § 111(a), of International Patent Application No. PCT/CN2024/099244, filed on Jun. 14, 2024, the disclosure of which is hereby incorporated into this disclosure by reference in its entirety.

### TECHNICAL FIELD

This disclosure relates to the field of computer technology, particularly to a communication method, an electronic device, a storage medium, and a product.

### BACKGROUND

With the development of Internet and artificial intelligence (AI) technology, users can chat with AI-controlled objects through electronic devices. For example, in application scenarios such as intelligent customer service, intelligent assistants, and intelligent Q&A, users can send questions to agents, and then the agents return answers.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

According to some embodiments of this disclosure, there is provided a communication method, including: determining, based on an input of a first object in an interaction interface between the first object and a second object, a target scene mode from one or more scene modes configured for the second object, wherein each of the scene modes is configured with a voice feature; and controlling the second object to perform a voice interaction with the first object based on a voice feature of the target scene mode.

According to some embodiments of this disclosure, there is provided an electronic device, including: at least one memory; at least one processor coupled to the memory, the processor configured to execute the communication method provided in any embodiment of the present disclosure based on instructions stored in the memory.

According to some embodiments of this disclosure, there is provided a non-transitory computer-readable storage medium stored thereon a computer program that, when executed by a processor, performs the communication method provided by any embodiment of the present disclosure.

According to some embodiments of this disclosure, there is provided a non-transitory computer program product that, when running on a computer, causes the computer to perform the communication method provided by any embodiment of the present disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Below, preferred embodiments of this disclosure will be described with reference to the drawings. The accompanying drawings described herein are intended to provide a further understanding of the present disclosure, and together with the specific description of the drawings below, are included in and constitute a part of the present specification for illustration of the present disclosure. It should be understood that the drawings described below merely involve some embodiments of the present disclosure, and are not limitations of the present disclosure. In the drawings:

FIG. 1 shows a flowchart of a communication method according to some embodiments of the present disclosure;

FIG. 2 shows a flowchart of a control method for voice interaction according to some embodiments of the present disclosure;

FIG. 3 shows a flowchart of a control method for voice interaction according to other embodiments of the present disclosure;

FIG. 4 shows a flowchart of a control method for voice interaction according to further embodiments of the present disclosure;

FIG. 5 shows a flowchart of a control method for voice interaction according to still other embodiments of the present disclosure;

FIGS. 6A, 6B, and 6C show schematic diagrams of communication interfaces according to some embodiments of the present disclosure;

FIG. 7 shows a schematic structure diagram of a communication apparatus according to some embodiments of the present disclosure;

FIG. 8 shows a schematic structure diagram of an electronic device according to some embodiments of the present disclosure;

FIG. 9 shows a schematic structure diagram of a computer system according to some embodiments of the present disclosure.

It should be understood that, for ease of description, the dimensions of the various parts shown in the drawings are not drawn to actual proportions. Throughout the drawings, the same or similar reference signs indicate the same or similar elements. Therefore, once an item is defined in a drawing, there is no need for further discussion in other accompanying drawings.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The description of the embodiments is merely illustrative, and in no way serves as any limitation on the present disclosure and its application or use. It should be understood that the present disclosure can be implemented in various forms and should not be construed as limited to the embodiments set forth herein.

It should be understood that the various steps described in the methods of the embodiments of the present disclosure may be executed in a different order, and/or executed in parallel. In addition, the methods may include additional steps and/or some of the illustrated steps may be omitted. The scope of this disclosure is not limited in this regard. Unless specifically stated otherwise, relative arrangement and values of components and steps, numerical expressions and values set forth in these embodiments are to be construed as merely illustrative, not limiting the scope of the present disclosure.

The term “comprising” and its variations used in this disclosure refer to an open-ended term that comprises at least the following elements/features, but does not exclude other elements/features, i.e. “comprising but not limited to”. In addition, the term “including” and its variations used in this disclosure refer to an open-ended term that includes at least the following elements/features, but does not exclude other elements/features, i.e., “including but not limited to”. Therefore, the terms “comprising” and “including” are synonymous. The term “based on” means “based at least in part on”.

“An embodiment”, “some embodiments” or “embodiments” used throughout the specification mean that specific features, structures or characteristics described in connection with the embodiments are included in at least one embodiment of the present invention. For example, the term “an embodiment” means “at least one embodiment”; the term “another embodiment” means “at least one additional embodiment”; the term “some embodiments” means “at least some embodiments”. In addition, occurrences of the phrases “in an embodiment,” “in some embodiments,” or “in embodiments” throughout this specification do not necessarily refer to the same embodiment, but may refer to the same embodiment.

It should be noted that the concepts of “first” and “second” mentioned in the present disclosure are only used to distinguish different devices, modules or units, and are not used to limit the order of functions performed by these devices, modules or units, or interdependence therebetween. Unless otherwise specified, terms such as “first” and “second” are not intended to imply that objects described in this way must be in any particular order in time, space, rank, or otherwise.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The following will provide a detailed explanation of the embodiments disclosed herein with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures or characteristics may be combined in any suitable manner, as will be apparent to those skilled in the art from this disclosure.

As the capabilities of agents (intelligent agents) continue to improve, conversations between users and agents are no longer limited to solving a specific problem for users, and the frequency and amount of information in the conversation has increased significantly. The method of sending messages sequentially through a conversation interface during multiple rounds of conversation is difficult to meet the needs of some users.

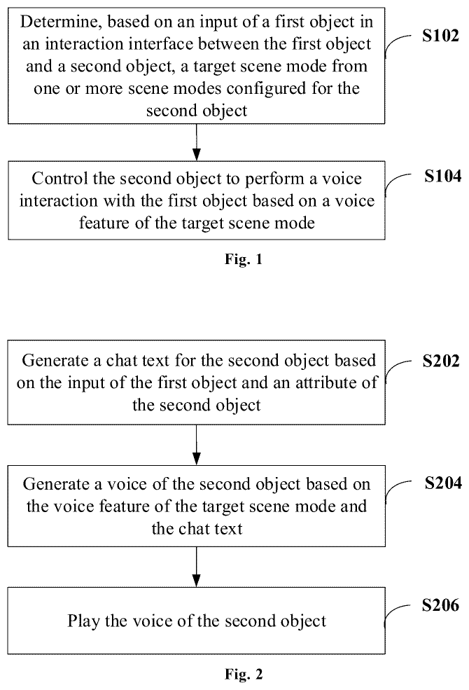

To improve the convenience of interaction with agents, this disclosure provides a communication method, an electronic device, a storage medium, and a product so that users or objects controlled by users can have voice interaction with agents, such as voice chat, to improve the efficiency of interaction with agents. In addition, the agent is configured with one or more scene modes, each with a corresponding voice feature, so that more interaction experiences can be produced according to different scene modes when interacting with the same agent. An embodiment of the communication method of this disclosure will be described below with reference to FIG. 1.

FIG. 1 shows a flowchart of a communication method according to some embodiments of the present disclosure. As shown in FIG. 1, the communication method of this embodiment includes steps S102-S104.

In step S102, based on an input of a first object in an interaction interface between the first object and a second object, a target scene mode is determined from one or more scene modes configured for the second object, wherein each of the scene modes is configured with a voice feature.

The first object may be a user; or the first object may be a user specified object, such as a first agent. The second object may be an agent, such as a second agent. That is, this embodiment support a scenario where a user has a voice call with an agent, as well as a scenario where a first agent has a voice call with a second agent. The user can initiate a communication with the second object in a terminal application, such as initiating a voice call on a conversation interface or initiating a voice call on the second object's homepage, and so on. The user can also choose a first agent and a second agent to initiate a communication between the two agents and observe their conversation content on the terminal.

In the case where the first object is the first agent, after the interaction between the first agent and the second agent is confirmed by the user, the first agent may act independently, with user intervention required only at the end of the interaction, or the first agent may be partially or fully controlled to perform certain behaviors during the interaction between the first agent and the second agent. During the voice call between the first agent and the second agent, the user can act as a observer to obtain information.

The agents can generate appropriate content based on the information they receive, such as text, voice, images, video, etc., and can be implemented in software, hardware, or a combination of software and hardware. Agents can also be referred to as robots, digital humans, virtual agents of machine learning models, etc., and can be implemented based on machine learning models, such as Large Language Models (LLM) or Foundation Models. Machine learning models can be generative models, which are used to output target content based on input information. The input information of a generative model includes the processing basis of the generative model during the generation process, such as what information is referenced to conduct the generation process, the requirements of the output target content, and so on. Generative models include models that generate based on text or images, and their output can be text, images or a combination of text and images. Of course, the input or output of generative models can also be data from other modalities, such as audio, video, or a combination of multiple types of data. Generative models may be single-modality models, such as the models that generate text based on text (referred to as “text to text-generation model”), or models that generate images based on images (referred to as “image to image generation model”); or generative models may also be cross-modality models, the input and output of which belong to different modalities, such as models that generate images based on texts (referred to as “text to image generation models”); or the input and output of generative models may be data from multiple modalities.

The interaction interface between the first object and the second object can be any interaction interface, such as a conversation interface or a voice call interface. In the case where the interaction interface is a conversation interface, the input of the first object includes text messages, voice messages, emojis, images, videos, instructions generated by triggering controls in the conversation interface, and so on. In the case where the interaction interface is a voice call interface, the input of the first object includes, for example, the content spoken by the first object during the voice call process, instructions generated by triggering controls in the voice call interface, as well as text messages, voice messages, emojis, images, videos, and so on sent via input controls provided by the voice call interface.

One or more scene modes configured for the second object have non-identical voice features. Each scene mode can belong to a different theme to provide a variety of voice call scenes. The voice feature is used to describe the characteristics of the voice output by the second object during voice call, which can reflect one or more of the second object's voice characteristics, language style, response characteristics, content characteristics, etc., thus providing users with a more sophisticated voice call experience.

The input of the first object can directly indicate a target scene mode. For example, information about one or more scene modes can be displayed in the interaction interface, and the scene mode selected by the first object can be determined as the target scene mode. As another example, by recognizing the text, voice (including voice messages in a conversation interface or voice content in a voice call), emojis, images, videos, files, etc. sent by the first object, it is possible to determine whether the content sent from the first object contains or is associated with a particular scene mode, and to determine the associated or contained scene mode as the target scene mode. In the latter example, one or more scene modes may displayed in the user interface, or may not be displayed in the user interface and the target scene mode can be selected directly in the background based on user input.

In step 104, the second object is controlled to perform a voice interaction with the first object based on a voice feature of the target scene mode.

In the voice interaction procedure, the voice generated by the second object matches the voice feature. For example, the voice of the second object is generated using the voice of the first object and voice feature during the voice interaction. When using a generative model to generate a voice for the second object, it is possible to first generate text that the second object is about to say, then generate a voice based on the text, and play the voice in a timely manner. In at least one of these two generation processes or the playback process, the generation or playback process can be completed based on the voice feature. In some embodiments, if the voice feature is represented in natural language, the voice feature and the voice content of the first object can be input into the generative model to obtain an output from the generative model. Of course, those skilled in the art can represent a voice feature in other ways, which will not be described in detail here.

The voice interaction between the first object and the second object includes a voice call. The voice call refers to an instant, real-time, and continuous voice conversation between the first object and the second object, similar to a telephone communication. In some embodiments, during a voice call, the first object may also interact with the second object in other ways, such as by sending text, emoji, video, images, files, and so on. It should be noted that voice calls in this application can also include a video call.

In the above embodiment, the one or more scene modes are configured for the second object interacting with the first object, and the target scene mode is determined based on the input from the first object to control the second object to perform voice interaction with the first object based on the target scene mode, thus enabling the second object to provide more extensive interactions during voice call, improving the efficiency and variety of information acquisition for the user, and enhancing the user experience.

Some embodiments of controlling the second object for voice interaction based on the target scene mode will be described below.

FIG. 2 shows a flowchart of a control method for voice interaction according to some embodiments of the present disclosure. In this embodiment, the process of controlling the second object for voice interaction is described from the perspective of chat text and voice generation. As shown in FIG. 2, the control method of this embodiment includes steps S202 to S206.

In step S202, a chat text is generated for the second object based on the input of the first object and an attribute of the second object.

The input of the first object includes the voice of the first object during the voice call, which includes the most recent voice spoken by the first object (such as the voice spoken within a specified time interval closest to a current time, or the voice spoken in a most recent round of voice conversation), so that the second object can respond more accurately to the most recent content spoken by the first object. In addition, the voice can include the voice previously spoken by the first object, so that the second object's response to the first object can take into account the previously discussed content.

The input of the first object can also include other content, such as text, emojis, videos, images, files, etc. entered by the first object through a voice call interface or a conversation interface during the voice call process. The second object can also respond based on these content.

The attributes of the second object, such as its setting information, describe the characteristics of the second object itself, for example, the second object's hobbies, major, gender, age, and so on. Thus, the generated text can conform to the characteristics of the second object.

In some embodiments, a generative model can be used to generate chat text. For example, the input of the first object and the attributes of the second object are fed into a text generation model to generate chat text. The information input to the text generation model can also include other content, which will not be further described here.

In step S204, a voice of the second object is generated based on the voice feature of the target scene mode and the chat text.

In some embodiments, the voice feature includes a sound feature, and generating the voice of the second object includes: generating the voice of the second object corresponding to the chat text based on the sound feature of the target scene mode. That is, the voice of the second object can fully correspond to the chat text. In some embodiments, the sound feature includes at least one of timbre, a speech rate, or tone of the second object. That is, the voice of the second object can be a complete retelling of the chat text according to a specific sound feature, such as the timbre, the speech rate, the tone, etc. Thus, the sound attributes of the generated voice can be matched with the target scene mode.

In some embodiments, the voice feature includes a language style feature, and generating the voice of the second object comprises: adjusting the chat text based on the language style feature of the target scene mode; and generating the voice of the second object based on the adjusted chat text. That is, the semantic meaning of the second object's voice can correspond to the chat text, i.e., the second object's voice expresses the main content of the chat text, only the manner of expression is adjusted. For example, if the target scene mode is put-to-sleep mode, the language style of sleep mode is “cute”, and the chat text is “Do you want a cat?”, the adapted chat text can be “Do you want a kitty?”, which can match the language style of the generated voice with the target scene mode.

The above sound feature and language style feature can be used separately or in combination. For example, the chat text can first be adjusted based on the language style feature, and then the voice of the second object can be generated based on the sound feature and the adjusted chat text.

In some embodiments, a generative model may be used to generate a voice. For example, the voice feature of the target scene mode and the chat text can be fed into a voice generation model to generate a voice. The information input to the voice generation model can also include other content, which will not be further described here.

In step S206, the voice of the second object is played.

In the above embodiment, it is possible to generate a chat text first, and then convert the chat text into a voice based on the voice feature. Therefore, the generated voice can have a voice feature that matches the target scene mode, thus improving the diversity of interaction in the voice interaction process.

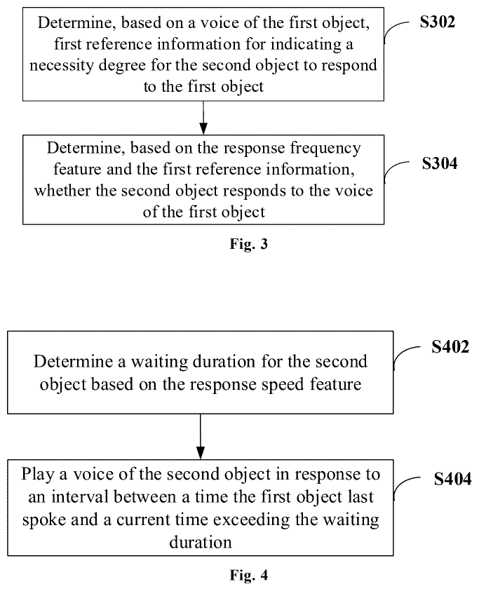

FIG. 3 shows a flowchart of a control method for voice interaction according to other embodiments of the present disclosure. In this embodiment, the voice feature includes a response frequency feature. As shown in FIG. 3, the control method of this embodiment includes steps S302 to S304.

In step 302, based on a voice of the first object, first reference information for indicating a necessity degree for the second object to respond to the first object is determined.

The first reference information can be represented by numbers, or by various types of information that can represent levels, or in some other way.

In some embodiments, intent recognition may be performed on the voice of the first object to determine the sentence type, content type, keywords, and other influencing factors of the content in the voice. For the sentence type, a response necessity of interrogative sentences may be higher than that of declarative sentences. For the content type, the response necessity of information-intensive content may be higher than that of content-sparse content. For example, if the first object says something like “Hmm . . . that is to say . . . you know what . . . how should I put it?”, although it says a lot of content, the information content is relatively sparse, and it is not necessary to make a response at this point. For keywords, some keywords can be set to have a high degree of response necessity, such as “split it out” or “tell me now” and so on. Taking into account the multiple influencing factors, the first reference information can be comprehensively determined by methods such as weighting.

In step S304, based on the response frequency feature and the first reference information, whether the second object responds to the voice of the first object is determined.

The value of the response frequency feature can represent different response frequency strategies that specify to what degree of necessity that the voice of the first object corresponds, it is necessary to make a response. For example, the value of the response frequency feature can be set to “Respond to any information,” “Respond only to information in the first necessity level,” “Respond only to information in the second necessity level,” and so on. In determining whether the second object will respond to the voice of the first object, it can be determined whether the first reference information satisfies a response strategy corresponding to the response frequency feature. If so, it is determined that the second object needs to make a response. For example, if the target scene mode is “Tree Hole (Listening Ear)” (the second object listens to the first object speak), the first user can be encouraged to speak as much as possible, while the second object responds only to information with a high degree of response necessity.

If it is determined that the second object will not respond to the voice of the first object, the second object does not need to speak but waits for the first object to speak.

In this embodiment, a response frequency feature is used to determine whether the second object needs to respond to the voice of the first object, thereby flexibly controlling the rhythm of the conversation based on the target scene mode and improving the user experience.

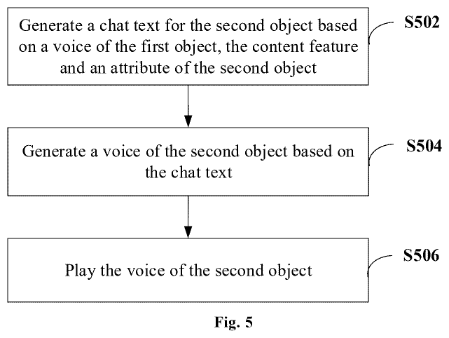

FIG. 4 shows a flowchart of a control method for voice interaction according to further embodiments of the present disclosure. In this embodiment, the voice feature includes a response speed feature. As shown in FIG. 4, the control method of this embodiment includes steps S402 to S404.

In step S402, a waiting duration for the second object is determined based on the response speed feature.

The response speed feature is used to directly or indirectly reflect the response duration of the second object, i.e., how long after the first object speaks, the second object speaks. The response speed feature can be a specific time, i.e., an actual waiting duration. It can also be a time level used to reflect the length of duration. For example, a response time can be determined based on the voice content of the first object and the time level, i.e., some voice content can be responded to immediately, and some voice content can be responded to later.

For example, if the target scenario mode is “Interview” and the first object is an interviewee, a slower response speed can be set to give the first object enough time to think and answer questions; for another example, if the target scene mode is “Comedy Performance”, a faster response speed can be set to generate denser lines and create a more cheerful atmosphere.

In step S404, a voice of the second object is played in response to an interval between a time the first object last spoke and a current time exceeding the waiting duration.

If the interval between the time the first object last spoke and the current time does not exceed the waiting duration, and the first object speaks again, the waiting duration is recalculated and the voice of the second object is not played. In this way, when the first object is speaking intensively, the second object will not easily interrupt, making it easier for the first object to say more content.

This embodiment utilizes response speed feature to determine when the second object responds to the voice of the first object, thereby flexibly controlling the rhythm of the conversation based on the target scene mode and improving the user experience.

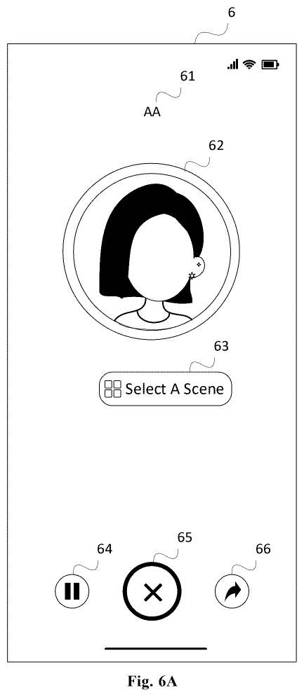

FIG. 5 shows a flowchart of a control method for voice interaction according to still other embodiments of the present disclosure. In this embodiment, the voice feature includes a content feature. As shown in FIG. 5, the control method of this embodiment includes steps S502 to S506.

In step S502, a chat text is generated for the second object based on a voice of the first object, the content feature and an attribute of the second object. That is, the voice feature configured for the target scene mode can also affect the conversation content of the second object.

In some embodiments, a text generation model can be used to process a voice (or text corresponding to that voice) of the first object, the content feature, and the attributes of the second object to generate the chat text. For example, in the “put-to-sleep” mode, the material for generating the chat text for the second object can come from some stories. In the “learning” mode, the material for generating the chat text for the second object can come from some professional materials.

In step S504, a voice of the second object is generated based on the chat text.

For example, a sound feature of the second object can be used directly to generate a voice corresponding to the chat text, or the solution of the previous embodiment can be used to fine-tune the chat text.

In step S506, the voice of the second object is played.

In this embodiment, the second object can generate corresponding conversation content based on the current target scene mode, so that the chat topic of the second object can also match the current target scene mode.

The above embodiments illustrate specific examples of the voice feature, which may include one or more of a sound feature, a language style feature, a response frequency feature, a response speed feature, or a content feature. The aforementioned embodiments can also be combined, which will not be described in detail.

The voice feature of each scene mode can be manually configured or automatically generated. In some embodiments, a voice feature is generated for the each scene mode based on attributes of the scene mode and attributes of the second object. For example, some agents are user-created, and configuring voice features for multiple scene modes of these agents individually may result in a relatively large configuration workload, and the efficiency of the configuration is not high. Through automatic generation, a voice feature that matches both the characteristics of the second object and the scene mode can be generated based on the attributes of the each scene mode and the attributes of the second object. For example, a generative model can be used to process the attributes of the scene mode and the attributes of the second object to generate a voice feature of the scene mode.

The scene modes provided in embodiments of the present disclosure include but are not limited to sleep-inducing mode, meditation, tree hole, foreign language learning, simulated Interview, wake-up, and so on. Below, interactions in several scene modes will be illustrated.

In some embodiments, the target scene mode is a first mode, such as a sleep-inducing mode. In the first mode, a communication between the first object and the second object is terminated in response to an interval between a time the first object last spoke and a current time exceeding a first threshold. That is, if the first object does not respond to the second object for a long time, it can be assumed that the first object has gone to sleep, and communication between the first object and the second object can be terminated to save resources.

In some embodiments, the target scene mode is a second mode, such as a foreign language learning mode. The voice feature of the second mode includes a language recognition instruction. In the second mode, a voice of the first object is recognized based on the language recognition instruction to determine a language used by the first object; a voice of the second object is generated using the language used by the first object; and the voice of the second object is played. That is, in the second mode, if the first object speaks in Chinese, the second object will also respond in Chinese; if the first object speaks in English, the second person will also respond in English. Therefore, the first object does not need to indicate the language used by the second object, which improves the efficiency of language learning.

In some embodiments, the target scene mode is a third mode, such as a meditation mode. In the third mode, the second object talks most of the time and the first object listens to the second object most of the time. The voice feature of the third mode includes a pause duration. In the third mode, a first voice generated for the second object is played; and in response to the first object remaining silent and after the pause duration elapses after the first voice is played, a second voice generated for the second object is played. For example, if the first object does not respond until a pause duration has elapsed after the second object has spoken a sentence, the second object can continue speaking. Thus, the second object can be guided into a meditative state.

In some embodiments, the target scene mode is a fourth mode, such as a wake-up mode. In the fourth mode, the first object can specify a wake-up time. Therefore, when the wake-up time arrives, the second object will actively initiate voice call with the first object and converse with the first object based on a voice feature of the wake-up mode.

Some embodiments of determining the target scene mode will be described below.

In some embodiments, the interaction interface is a communication interface (voice call interface), and determining the target scene mode includes: displaying one or more scene modes in the communication interface; determining the target scene mode based on an operation for selecting a scene mode of the first object.

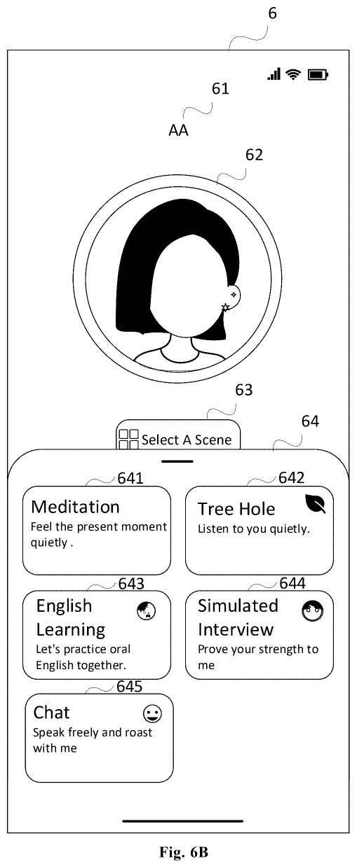

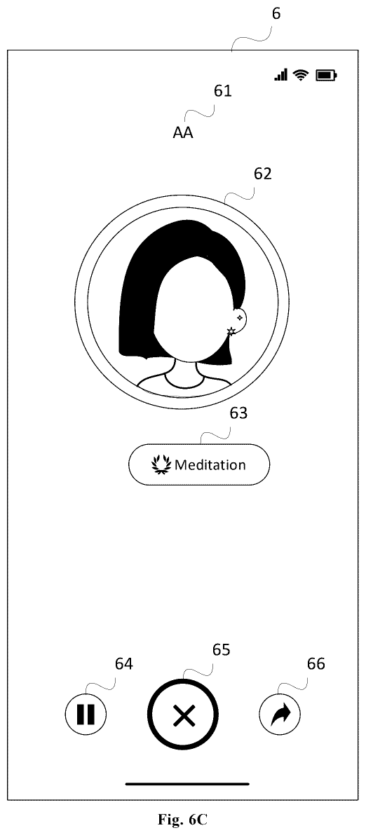

FIGS. 6A, 6B, and 6C illustrate schematic diagrams of communication interfaces according to some embodiments of the present disclosure. The communication interface can be a communication interface between a user and an agent, or a communication interface between two agents. As shown in FIG. 6A, information about an agent AA acting as a second object, such as its nickname 61 and avatar 62, etc., is displayed in a communication interface 6. The communication interface 6 also includes a selection control 63, which is used to trigger the process of selecting a target scene mode from one or more scene modes. For example, in response to the selection control 63 being triggered, an interface as shown in FIG. 6B can be displayed.

In FIG. 6B, the communication interface 6 also includes a selection panel 64, which includes one or more scene mode selection controls 641 to 645, corresponding to scenes “Meditation”, “Tree Hole”, “English Learning”, “Simulated Interview”, and “Chat”, respectively. In response to any one of the controls 641 to 645 being triggered, a scene mode corresponding to the triggered control is determined as the target scene mode, and the agent AA is controlled to perform voice interaction based on a voice feature of the target scene mode.

For example, after the “meditation” mode is selected, the communication interface 6 shown in FIG. 6C can be displayed. In FIG. 6C, the name of the target scene mode is displayed on the selection control 63, so that the user can have a clearer understanding of the current scene mode. In response to the selection control 63 being triggered again, the communication interface 6 can be switched back to a state similar to that shown in FIG. 6B.

A pause control 64, a hang up control 65, and a share control 66, etc. can also be provided in the communication interface 6. The pause control 64 is used to pause a voice call and resume from the previously paused position when the voice call is resumed. The hang up control 65 is used to terminate a voice call. The share control 66 is used to share the agent (i.e. the second object) or part of the content in the communication with other users.

In some embodiments, the interaction interface is a conversation interface, and determining the target scene mode includes: receiving the input of the first object in the conversation interface; performing semantic understanding on the input of the first object; and determining a scene mode that matches a semantic understanding result from the one or more scene modes as the target scene mode. When matching, the understanding result of the input of the first object can be matched with the name, description, attributes, voice feature, etc. of a scene mode to determine the target scene mode. For example, during a conversation between the first object and the second object, the first object sends a message on the conversation interface saying “I have a job interview tomorrow, would you like to help me practice in advance?” By understanding the semantic meaning of the input, it is found that the input matches the scene mode “Simulated Interview”. Then, a voice call can be initiated between the first object and the second object, directly entering the Simulated Interview mode. Of course, if necessary, the first object can be asked to confirm the process of initiating voice call before initiating voice call.

In addition, a voice call and a conversation can be carried out in parallel. For example, during a voice call, it is also possible to send a message to the second object through the conversation interface without hanging up the voice call. For example, the voice call interface can be shrunk and floated over the conversation interface. Therefore, the content input by the first object in the conversation interface can also affect the scene mode or content of the voice call.

In some embodiments, the interaction interface is a voice call interface, and determining the target scene mode comprises: receiving a voice of the first object in the voice call interface; performing semantic understanding of the voice of the first object; and determining a scene mode that matches a semantic understanding result among one or more scene modes as the target scene mode. For example, during a voice call, the first object might say, “I′m going to start meditating.” By understanding the semantic meaning of the spoken content, it can be determined that it matches the scene mode “Meditation”, and then the meditation mode can be entered automatically. Of course, before entering the target scene mode determined by semantic understanding, it is also possible to ask if the first object confirms the selection as needed.

The communication methods provided by embodiments of the present disclosure have been discussed above. An apparatus for implementing the methods of the above embodiments will be further introduced below.

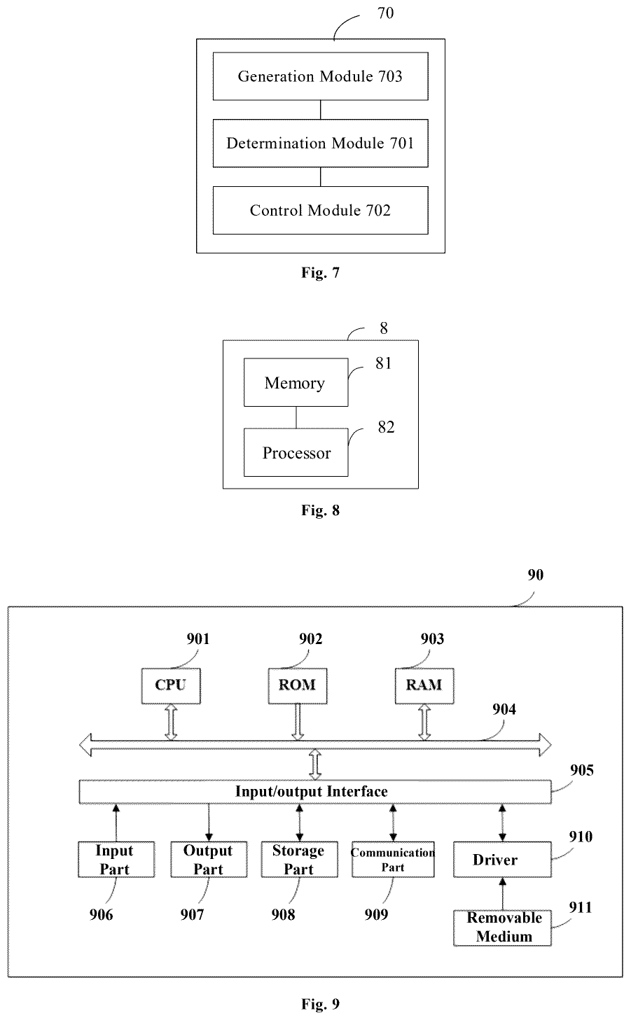

FIG. 7 shows a schematic structure diagram of a communication apparatus according to some embodiments of the present disclosure. As shown in FIG. 7, a conversation apparatus 70 of this embodiment includes: a determination module 701 configured for determining, based on an input of a first object in an interaction interface between the first object and a second object, a target scene mode from one or more scene modes configured for the second object, wherein each of the scene modes is configured with a voice feature; and a control module 702 configured for controlling the second object to perform a voice interaction with the first object based on a voice feature of the target scene mode.

In some embodiments, the control module 702 is further configured for: generating a chat text for the second object based on the input of the first object and an attribute of the second object; generating a voice of the second object based on the voice feature of the target scene mode and the chat text; and playing the voice of the second object.

In some embodiments, the voice feature includes a sound feature, and the control module 702 is further configured for: generating the voice of the second object corresponding to the chat text based on the sound feature of the target scene mode.

In some embodiments, the sound feature comprises at least one of timbre, a speech rate, or tone of the second object.

In some embodiments, the voice feature includes a language style feature, and the control module 702 is further configured for: adjusting the chat text based on the language style feature of the target scene mode; and generating the voice of the second object based on the adjusted chat text.

In some embodiments, the voice feature includes a response frequency feature, and the control module 702 is further configured for: determining, based on a voice of the first object, first reference information for indicating a necessity degree for the second object to respond to the first object; and determining, based on the response frequency feature and the first reference information, whether the second object responds to the voice of the first object.

In some embodiments, the voice feature includes a response speed feature, and the control module 702 is further configured for: determining a waiting duration for the second object based on the response speed feature; and playing a voice of the second object in response to an interval between a time the first object last spoke and a current time exceeding the waiting duration.

In some embodiments, the voice feature includes a content feature, and the control module 702 is further configured for: generating a chat text for the second object based on a voice of the first object, the content feature and an attribute of the second object; generating a voice of the second object based on the chat text; and playing the voice of the second object.

In some embodiments, the target scene mode is a first mode, and the control module 702 is further configured for: terminating a communication between the first object and the second object in response to an interval between a time the first object last spoke and a current time exceeding a first threshold.

In some embodiments, the target scene mode is a second mode, the voice feature of the second mode comprises a language recognition instruction, and the control module 702 is further configured for: recognizing a voice of the first object based on the language recognition instruction to determine a language used by the first object; generating a voice of the second object using the language used by the first object; and playing the voice of the second object.

In some embodiments, the target scene mode is a third mode with a voice feature including a pause duration, and the control module 702 is further configured for: playing a first voice generated for the second object; and playing, in response to the first object remaining silent and after the pause duration elapses after the first voice is played, a second voice generated for the second object.

In some embodiments, the communication apparatus 70 further comprises: a generation module 703 configured for generating a voice feature for each scene mode of the scene modes based on an attribute of the scene mode and an attribute of the second object.

In some embodiments, the interaction interface is a communication interface, and the determination module 701 is further configured for: displaying the one or more scene modes in the communication interface; and determining the target scene mode based on an operation for selecting a scene mode of the first object.

In some embodiments, the interaction interface is a conversation interface, and the determination module 701 is further configured for: receiving the input of the first object in the conversation interface; performing semantic understanding on the input of the first object; and determining a scene mode that matches a semantic understanding result from the one or more scene modes as the target scene mode.

In some embodiments, the first object is a user or a first agent; and the second object is a second agent.

It should be noted that the above units are only logical modules divided according to their specific functions and are not intended to limit the specific ways in which they are implemented. For example, they may be implemented in software, hardware or a combination of software and hardware. In practical implementation, the above units may be implemented as independent physical entities, or they can also be implemented by a single entity (such as a processor (CPU or DSP), integrated circuit, etc.). In addition, the above units are indicated by dashed lines in the accompanying drawings, indicating that these units may not actually exist and that the operations/functions they perform may be performed by a processing circuit per se.

In addition, although not shown, the device may also include a memory that can store various information generated by the device or various units in the device during operation, programs and data used for operation, data to be sent by a communication unit, and so on. The memory may be volatile memory and/or non-volatile memory. For example, the memory may include, but is not limited to, random access memory (RAM), dynamic random access memory (DRAM), static random access memory (SRAM), read-only memory (ROM), and flash memory. Of course, the memory may also be located outside of the device. Optionally, although not shown, the device may also include a communication unit that may be used to communicate with other apparatus. In an example, the communication unit may be implemented in any suitable manner known in the art, including communication components such as an antenna array and/or radio frequency links, various types of interfaces, communication units, and so on, which will not be described in detail herein. In addition, the device may also include other components not shown, such as a RF link, a baseband processing unit, a network interface, a processor, a controller, etc., which will not be described in detail herein.

Some embodiments of the present disclosure further provide an electronic device. FIG. 8 shows a schematic structure diagram of an electronic device according to some embodiments of the present disclosure. For example, in some embodiments, the electronic device 8 may be any type of electronic device, such as, but not limited to, a mobile terminal such as a mobile phone, a laptop, a digital broadcast receiver, a PDA (personal digital assistant), a PAD (tablet computer), a PMP (portable multimedia player), a vehicle terminal (such as vehicle navigation terminal), or a fixed terminal such as a digital TV, a desktop computer, etc. For example, the electronic device 8 may include a display panel for displaying data and/or execution results utilized in the scheme of the present disclosure. For example, the display panel can have various shapes. For example, it can be a rectangular panel, an elliptical panel, or a polygonal panel. Furthermore, the display can be not only flat, but curved or even spherical.

As shown in FIG. 8, the electronic device 8 of this embodiment comprises: a memory 81 and a processor 82 coupled to the memory 81. It should be noted that the components of the electronic device 8 shown in FIG. 8 are illustrative and not limiting. Depending on the actual application requirements, the electronic device 8 may include other components. The processor 82 can control other components in the electronic device 8 to perform desired functions.

In some embodiments, the memory 81 is used to store one or more computer-readable instructions. The processor 82 is used to execute these computer-readable instructions that, when executed by the processor 82, perform the method according to any of the above embodiments. The specific implementation of each step of the method and related explanations can be found in the above embodiments, and will not be repeated here.

For example, the processor 82 and the memory 81 can directly or indirectly communicate with each other. For example, the processor 82 and the memory 81 can communicate over a network. The network can be a wireless network, a wired network, and/or any combination of wireless and wired networks. The processor 82 and the memory 81 may also communicate with each other over a system bus, and this disclosure is not limited thereto.

For example, the processor 82 may be embodied as various suitable processors, processing devices, etc., such as a central processing unit (CPU), a graphics processing unit (GPU), a network processor (NP), etc.; It can also be a digital signal processor (DSP), an application specific integrated circuit (ASIC), a field programmable gate array (FPGA), or other programmable logic devices, discrete gates or transistor logic devices, or discrete hardware components. The central processing unit (CPU) may be based on the X86 or ARM architecture. For example, the memory 81 may include any combination of various forms of computer-readable storage media, such as volatile memory and/or non-volatile memory. The memory 81 may include a system memory, which stores an operating system, application programs, a boot loader, a database, and other programs. Various applications and data can also be stored in the storage media.

In addition, according to some embodiments of the present disclosure, various operations/processes according to the present disclosure may be implemented by software and/or firmware, and programs constituting the software may be installed, from storage media or networks, on a computer system having dedicated hardware structures, such as the computer system 90 shown in FIG. 9. The computer system with various programs installed can perform various functions, including those functions mentioned above. FIG. 9 shows a schematic structure diagram of a computer system according to some embodiments of the present disclosure.

In FIG. 9, the central processing unit (CPU) 901 performs various processes based on programs stored in the read-only memory (ROM) 902 or programs loaded from the storage device 908 to the random access memory (RAM) 903. Data required for CPU 901 to perform various processes is also stored in RAM 903 as needed. The central processing unit is only an example and can also be other types of processors, such as the various processors mentioned above. The ROM 902, RAM 903, and storage section 908 may be various forms of computer readable storage media, as described below. It should be noted that although ROM 902, RAM 903, and storage device 908 are shown separately in FIG. 9, one or more of them may be combined or located in the same or different memory or storage modules.

The CPU 901, the ROM 902, and the RAM 903 are connected to each other via a bus 904. An input/output (I/O) interface 905 is also connected to the bus 904.

The following components are connected to the input/output interface 905: an input section 906, such as a touch screen, a touch pad, a keyboard, a mouse, an image sensor, a microphone, an accelerometer, a gyroscope, etc.; an output section 907, including a display such as a cathode ray tube (CRT), liquid crystal display (LCD), a speaker, a vibrator, etc.; a storage section 908, including a hard disk drive, a magnetic tape drive, etc.; and a communication section 909 including a network interface card, such as a LAN card, a modem, etc. The communication section 909 allows communication to be performed over a network, such as the Internet. It is easy to understand that although the various devices or modules in the computer system 90 are shown in FIG. 9 communicating over the bus 904, they may also communicate over networks or other means, where the networks may include wireless networks, wired networks, and/or any combination of wireless and wired networks.

A drive 910 is also connected to input/output interface 905 as needed. A removable medium 911, such as a magnetic disk, an optical disk, a magneto-optical disk, a semiconductor memory, etc., is mounted on the drive 910 as needed so that computer programs read from the medium can be installed in the storage section 908 as needed.

In the case of implementing the above series of processes by software, the programs that make up the software may be installed from a network, such as the Internet, or from a storage medium, such as the removable media 911.

According to an embodiment of the present disclosure, the processes described above with reference to the flowchart can be implemented as a computer software program. For example, some embodiments of the present disclosure include a computer program product comprising a computer program carried on a computer-readable medium, the computer program containing program code for performing the method illustrated in the flowcharts. In such an embodiment, the computer program may be downloaded and installed from the network via the communication device 909, or installed from the storage device 908 or from the ROM 902. When the computer program is executed by a CPU 901, the above functions defined in the method provided by the embodiment of the present disclosure are performed.

It should be noted that, in the context of the present disclosure, a computer-readable medium may be a tangible medium, which may contain or store a program for use by or in connection with an instruction execution system, apparatus, or device. The computer readable medium may be a computer readable signal medium or a computer readable storage medium, or any combination of thereof. The computer readable storage medium may be, but is not limited to: an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

The above computer readable medium may be included in the electronic device described above; or it may exist alone without being assembled into the electronic device.

In some embodiments, there is further provided a computer program, comprising: instructions that, when executed by a processor, cause the processor to perform the communication method provided in any of the above embodiments. For example, the instructions can be embodied as computer program code.

In embodiments of the present disclosure, computer program code for executing operations of the present disclosure may be complied by any combination of one or more program design languages, the program design languages including, but not limited to, object-oriented program design languages, such as Java, Smalltalk, C++, etc., as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area networks (LAN) or wide area networks (WAN), or connected to external computers (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules, components or units involved in the embodiments described in the present disclosure can be implemented by software or hardware. Wherein, the names of the modules, components or units do not constitute a limitation on the modules, components or units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

The above description only shows some embodiments of the present disclosure and illustrates technical principles applied in the present disclosure. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

Many specific details are elaborated in the description of the present disclosure. However, it is understood that embodiments of the present invention can be implemented without these specific details. In other cases, well-known methods, structures, and techniques are not described in detail so as not to obscure the understanding of the description.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A communication method, comprising:
determining, based on an input of a first object in an interaction interface between the first object and a second object, a target scene mode from one or more scene modes configured for the second object, wherein the second object is an agent, each of the scene modes is configured with a voice feature, and the voice feature comprises a response speed feature; and
controlling the second object to perform a voice interaction with the first object based on a voice feature of the target scene mode, comprising:
generating, by a generative model for outputting audio, a voice of the second object using the voice of the first object and the voice feature during the voice interaction;
determining a waiting duration for the second object based on the response speed feature; and
playing the voice of the second object in response to an interval between a time the first object last spoke and a current time exceeding the waiting duration.

2. The communication method according to claim 1, wherein the controlling the second object to perform the voice interaction with the first object based on the voice feature of the target scene mode comprises:
generating a chat text for the second object based on the input of the first object and an attribute of the second object;
generating a voice of the second object based on the voice feature of the target scene mode and the chat text; and
playing the voice of the second object.

3. The communication method according to claim 2, wherein the voice feature comprises a sound feature, and the generating the voice of the second object based on the voice feature of the target scene mode and the chat text comprises:
generating the voice of the second object corresponding to the chat text based on the sound feature of the target scene mode.

4. The communication method according to claim 3, wherein the sound feature comprises at least one of timbre, a speech rate, or tone of the second object.

5. The communication method according to claim 2, wherein the voice feature comprises a language style feature, and the generating the voice of the second object based on the voice feature of the target scene mode and the chat text comprises:
adjusting the chat text based on the language style feature of the target scene mode; and
generating the voice of the second object based on the adjusted chat text.

6. The communication method according to claim 1, wherein the voice feature comprises a response frequency feature, and the controlling the second object to perform the voice interaction with the first object based on the voice feature of the target scene mode comprises:
determining, based on a voice of the first object, first reference information for indicating a necessity degree for the second object to respond to the first object; and
determining, based on the response frequency feature and the first reference information, whether the second object responds to the voice of the first object.

7. (canceled)

8. The communication method according to claim 1, wherein the voice feature comprises a content feature, and the controlling the second object to perform the voice interaction with the first object based on the voice feature of the target scene mode comprises:
generating a chat text for the second object based on a voice of the first object, the content feature and an attribute of the second object;
generating a voice of the second object based on the chat text; and
playing the voice of the second object.

9. The communication method according to claim 1, wherein the target scene mode is a first mode, and the communication method further comprises:
terminating a communication between the first object and the second object in response to an interval between a time the first object last spoke and a current time exceeding a first threshold.

10. The communication method according to claim 1, wherein the target scene mode is a second mode, the voice feature of the second mode comprises a language recognition instruction, and the controlling the second object to perform the voice interaction with the first object based on the voice feature of the target scene mode comprises:
recognizing a voice of the first object based on the language recognition instruction to determine a language used by the first object;
generating a voice of the second object using the language used by the first object; and
playing the voice of the second object.

11. A communication method, comprising:
determining, based on an input of a first object in an interaction interface between the first object and a second object, a target scene mode from one or more scene modes configured for the second object, wherein the second object is an agent, and each of the scene modes is configured with a voice feature; and
controlling the second object to perform a voice interaction with the first object based on a voice feature of the target scene mode, wherein
in response to the target scene mode being a third mode, the voice feature of the third mode comprises a pause duration, and the controlling the second object to perform the voice interaction with the first object based on the voice feature of the target scene mode comprises:
generating, by a generative model for outputting audio, a first voice of the second object using the voice of the first object and the voice feature during the voice interaction;
playing the first voice generated for the second object; and
playing, in response to the first object remaining silent and after the pause duration elapses after the first voice is played, a second voice generated for the second object.

12. The communication method according to claim 1, further comprising:
generating a voice feature for each scene mode of the scene modes based on an attribute of the scene mode and an attribute of the second object.

13. The communication method according to claim 1, wherein the interaction interface is a communication interface, and the determining, based on the input of the first object, the target scene mode from the one or more scene modes configured for the second object comprises:
displaying the one or more scene modes in the communication interface; and
determining the target scene mode based on an operation for selecting a scene mode of the first object.

14. The communication method according to claim 1, wherein the interaction interface is a conversation interface, and the determining, based on the input of the first object, the target scene mode from the one or more scene modes configured for the second object comprises:
receiving the input of the first object in the conversation interface;
performing semantic understanding on the input of the first object; and
determining a scene mode that matches a semantic understanding result from the one or more scene modes as the target scene mode.

15. The communication method according to claim 1, wherein:
the first object is a user or a first agent; and
the second object is a second agent.

16. An electronic device, comprising:
a memory; and
a processor coupled to the memory, the processor configured to, based on instructions stored in the memory, carry out a communication method comprising:
determining, based on an input of a first object in an interaction interface between the first object and a second object, a target scene mode from one or more scene modes configured for the second object, wherein the second object is an agent, each of the scene modes is configured with a voice feature, and the voice feature comprises a response speed feature; and
controlling the second object to perform a voice interaction with the first object based on a voice feature of the target scene mode, comprising:
generating, by a generative model for outputting audio, a voice of the second object using the voice of the first object and the voice feature during the voice interaction;
determining a waiting duration for the second object based on the response speed feature; and
playing the voice of the second object in response to an interval between a time the first object last spoke and a current time exceeding the waiting duration.

17. The electronic device according to claim 16, wherein the controlling the second object to perform the voice interaction with the first object based on the voice feature of the target scene mode comprises:
generating a chat text for the second object based on the input of the first object and an attribute of the second object;
generating a voice of the second object based on the voice feature of the target scene mode and the chat text; and
playing the voice of the second object.

18. The electronic device according to claim 17, wherein the voice feature comprises a sound feature, and the generating the voice of the second object based on the voice feature of the target scene mode and the chat text comprises:
generating the voice of the second object corresponding to the chat text based on the sound feature of the target scene mode.

19. The electronic device according to claim 17, wherein the voice feature comprises a language style feature, and the generating the voice of the second object based on the voice feature of the target scene mode and the chat text comprises:
adjusting the chat text based on the language style feature of the target scene mode; and
generating the voice of the second object based on the adjusted chat text.

20. A non-transitory computer-readable storage medium stored thereon a computer program that, when executed by a processor, implements a communication method comprising:
determining, based on an input of a first object in an interaction interface between the first object and a second object, a target scene mode from one or more scene modes configured for the second object, wherein the second object is an agent, each of the scene modes is configured with a voice feature, and the voice feature comprises a response speed feature; and
controlling the second object to perform a voice interaction with the first object based on a voice feature of the target scene mode, comprising:
generating, by a generative model for outputting audio, a voice of the second object using the voice of the first object and the voice feature during the voice interaction;
determining a waiting duration for the second object based on the response speed feature; and
playing the voice of the second object in response to an interval between a time the first object last spoke and a current time exceeding the waiting duration.

21. An electronic device, comprising:
a memory; and
a processor coupled to the memory, the processor configured to, based on instructions stored in the memory, carry out the communication method of claim 11.
